(19) United States
(12) Patent Application Publication
(10) Pub. No.: US 2010/0290212 A1
(43) Pub. Date: Nov. 18, 2010

(54) Low mechanical impact detacthable display

(76) Inventor: Glen Max Francis, Raleigh, NC (US)

Correspondence Address: Glen Max Francis, 2301 Auburn Knightdale Rd., Raleigh, NC, 27610, US

(21) Appl. No.: 12/454,414

(22) Filed: May 18, 2009

(51) Int. Cl. G02F 1/13357; G09F 7/18; G09F 7/04

(52) U.S. Cl. 362/97.3; 40/611.01; 40/600

(57) ABSTRACT

A display system utilizing low mechanical impact materials that are mounted with easily detachable connectors and rapidly changeable information content. Perpendicular mounting often enhances communication to pedestrians while soft edge materials maintain safety to users and prevents damage to the sign. User changeable sign content includes office printed sheets and LCD dynamic information displays. The system allows for both continuous use and rapid deployment in transitory or emergencies situations.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

Invention relates to advertising and informational displays and signs.

2. Prior Art

Displays and signs attached flat to a mounting surface are common. People are not likely to be injured by accidentally walking into such a display. Also, such displays are not likely to detach thus causing injury or property damage.

Displays and signs mounted perpendicularly are in use, but are routinely attached firmly to prevent injury or property damage due to detachment or impact. U.S. Pat. No. 4,028,827 by Hufton discloses a magnetic mounted sign with a perpendicular rod flag holder. While Hufton's device shows that such a concept is patentable, contains the quick attachment features, and perpendicular display; Hufton's device lacks low mechanical impact features and the ability use standard office paper in a sheet holder so that sign content can be quickly changed.

3. Objects and Advantages

(a) reduce the chance of injury or property damage caused by someone walking directly into a perpendicularly mounted sign or display.

(b) reduce the chance of injury or property damage caused by accidental detachment and consequential impact.

(c) to provide a means to rapidly install a sign or display perpendicular to the mounting surface, and to rapidly relocate such display.

(d) rapidly change the message displayed.

(e) to enhance visibility from a distance by perpendicular mounting.

(f) to prevent damage to the mounting surface caused by using permanent fasteners.

### SUMMARY

This patent describes displays and/or signs with enhanced safety, increased visibility, ease of installation, rapid information change, and greater design flexibility.

### DRAWINGS—FIGURES

FIG. 1 shows an example embodiment applied to a typical office hallway situation in which the display is suspended out into the hallway at an approximate right angle to the wall.

FIG. 2 provides an exploded view of the apparatus from FIG. 1. This is also a view of how users can disassemble and change the display contents.

FIG. 3 is a cross section from FIG. 2.

FIG. 4 is an example embodiment with some 3D aspects shown.

FIG. 5 illustrates a simple example embodiment with a variation in the display attachment method.

FIG. 6 provides an exploded view of the apparatus from FIG. 5.

FIG. 7 is a cross section from FIG. 6.

FIG. 8 shows another example embodiment and another type of display attachment method.

FIG. 9 is a close up of the attachment device associated with FIG. 8.

FIG. 10 is a close up of the attachment device of FIG. 8 with one of two sides opened.

FIG. 11 is a simple optional accessory to provide magnetic attachment on non-magnetic surfaces.

FIG. 12 discloses a low damage accessory to use magnetic attachment on non-magnetic surfaces.

FIG. 13 is a non-magnetic, bulge and hole bracket attachment method. Only one set is shown but two or more are typically used per display.

FIG. 14 displays the device of FIG. 13 from another angle.

FIG. 15 is a cross section of the device from FIG. 13 and FIG. 14.

FIG. 16 is a LCD encased in soft protective material with a swivel option. The swivel is shown with the display protruding at an approximate right angle to the mounting surface.

FIG. 17 is the same device of FIG. 16 shown with a swivel option shown flat against the mounting surface.

FIG. 18 is a exploded diagram of the device of FIG. 16.

### DRAWINGS—REFERENCE NUMBERS

10 Display or sign page
11 Optional display or sign like 10 above, but installed facing the opposite direction
12 Slot to allow the insertion and removal of 10 or optionally 10 and 11
13 Clear, or mostly clear, display holder or sheet protector
14 Bulge, similar to a plastic drinking straw
15 Display support bracket
16 Display receiving hole
17 Display receiving slot
18 End of display receiving slot
19 Magnet (two shown)
20 Magnet receiving pocket (two shown)
21 Rounded corners and beveled edges for safety
22 Rounded corners for safety
23 Safety cable
24 Safety cable connection loop
25 Loop retaining clasp
26 Safety cable insertion hole
30 Display support bracket with example 3D logo and 3D lettering
31 Rounded corners and beveled edges for safety
32 Magnet, installed (two shown)
33 Paper display attached directly on the bracket
34 Raised lettering example
35 Raised company logo example
36 Reverse side identical to the front side to allow viewing from either approach
40 Clear, or mostly clear, display holder or sheet protector
41 Display or sign page
42 Slot to allow the insertion and removal of 41
43 Display support bracket
44 Display sheet protector attachment pin
45 Attachment pin hole
46 Grommet hole in the sheet protector
47 Display receiving slot
48 Lower magnet
49 Upper magnet
50 Mounting surface
51 Clear, or mostly clear, display holder or sheet protector
52 Display or sign page
53 Slot to allow the insertion and removal of 52
54 Display support bracket
55 Magnetic attachment (not shown)
56 Snap attachment leg, left
57 Snap attachment leg, right
58 Grooves to allow attachment legs to bend out
59 Support post
60 Flutes allow easy insertion into the support bracket but make removal difficult
61 Snap pin, male
62 Snap hole, female
70 Screw
71 Magnet attachment surface
72 Beveled hole
73 Non-magnetic mounting surface
75 Magnet attachment surface
76 Adhesive pad, double sided
77 Adhesive pad removal tab
78 Non-magnetic mounting surface
80 Display support bracket, partial view
81 Attachment hole
82 Screw
83 Attachment ball
84 Hole that runs through the attachment ball to accept the screw
85 Mounting surface
90 Display support bracket
91 Liquid Crystal Display unit including backlight, microprocessor, storage memory, and communication interface.
92 Rechargeable battery
93 Battery compartment providing magnet attachment points and swivel support
94 Battery compartment door
95 Attachment magnet, upper also used to conduct electrical current
96 Attachment magnet, lower also used to conduct electrical current
97 Swivel bearing tube, lower
98 Swivel bearing tube, upper
99 Swivel bearing hole (two)
100 Swivel bearing hole (two)
101 Liquid crystal display slot
102 Insulated electrical wires to carry power to 91
103 Insulated electrical wire carries power to the battery, upper
104 Insulated electrical wire carries power to the battery, lower

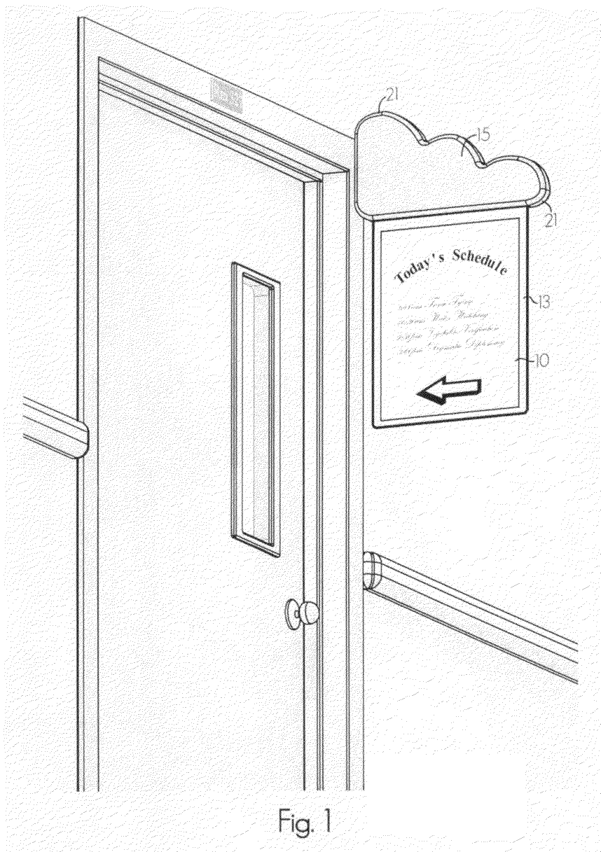

### DETAILED DESCRIPTON—FIGS. 1-3 PREFERRED EMBODIMENT

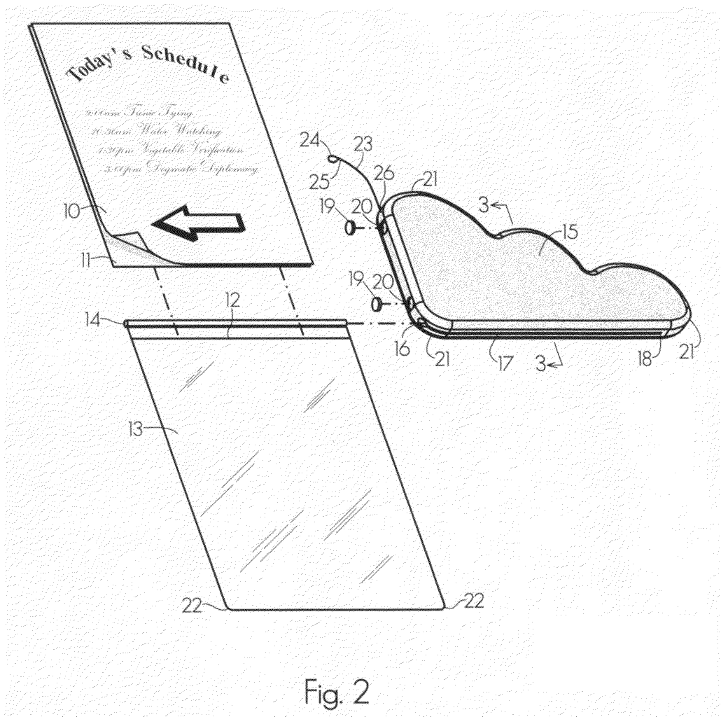

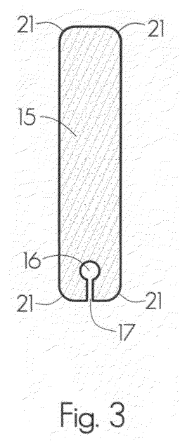

A preferred embodiment is illustrated in FIG. 1 (fully assembled, office door application), FIG. 2 (exploded view and assembly view), and FIG. 3 (cross section).

A sign or display 10 consisting of common paper, photographic print, or thin plastic is provided by the customer or vendor. The display page 10 can be printed on both front and back or a second display page 11 can be included facing the opposite direction of 10. This allows the display to be seen while traveling in either direction of a hallway.

Slot 12 is an opening for inserting display page(s) into a clear or mostly clear display holder or sheet protector 13 similar to, for example, a modified vinyl “Job Ticket Holder” from Avery® Dennison Corporation of Bera Calif. A bulge 14 at the top of the sheet protector 13 can be formed by ultrasonic heat welding a light plastic tube, similar to a drinking straw, between layers of the top vinyl compartment of the existing product mentioned above. This sheet protector has rounded corners 22 to minimize impact damage.

Hole 16 and slot 17 in the display support bracket 15 provide a means of installation and removal for the sheet protector 13. The hole and slot are large enough to easily install the sheet protector and bulge up to the end of the slot 18. The sheet protector may also be removed by sliding out the back of the support bracket.

The display support bracket 15 is typically composed of soft foam such as low density polyethylene or craft foam. Important characteristics include: being soft enough to reduce the likelihood of injury or property damage, being rigid enough to hold the sign or display without sagging, and being durable enough to withstand daily handling and occasional impacts.

The display bracket 15 can be attached to various mounting surfaces via magnets 19 (two shown) that are permanently adhered into magnet receiving pockets 20 (two shown). The depth of the these pockets are such that the magnets are nearly flush with the back of the display bracket, but the magnets slightly protrude to insure good contact with the mounting surface.

All display bracket edges and corners 21 are rounded and beveled to minimize impact damage.

A thin safety cable 23 made of nearly clear flexible nylon is formed into a loop 24 that can be attached with a screw or other fastening device into the mounting surface. The safety cable loop 24 is held together by a loop retaining clasp 25 typically made of crimped stainless steel. The safety cable 23 is attached to the display support bracket 15 by means of adhesive in a hole 26 in the display support bracket.

### Operation FIGS. 1-3 Preferred Embodiment

The display page(s) 10 (and optionally 11) can be produced by an office computer printer, photocopy machine, vinyl cutter, photo lab, or hand drawn. With the display holder 13 withdrawn from the display support bracket 15 as shown in FIG. 2, the display page(s) are fully inserted into the display holder using slot 12.

The display pages 10&11 and display holder 13 that are now assembled are next inserted into the display bracket 15 via a hole 16 and slot 17 until reaching the end of the slot 18. The bulge 14 is large enough to prevent the display holder 13 from falling out of the bracket under normal use, but can slide in and out as often as necessary to change the display content.

FIG. 3 is a cross section of the display support bracket showing the hole 16 and slot 17. The bulge 14 is slightly smaller in diameter than hole 16 and the width of the sheet protector 13 is slightly less than slot 17. The bulge 14 is somewhat wider than slot 17, thus the sheet protector assembly can be slide into the support bracket 15 and will not fall out under the force of gravity on the sheet protector assembly.

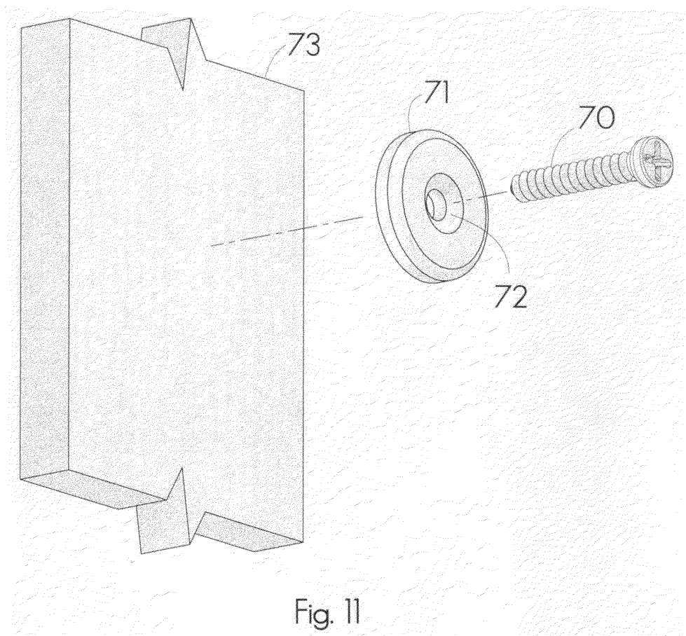

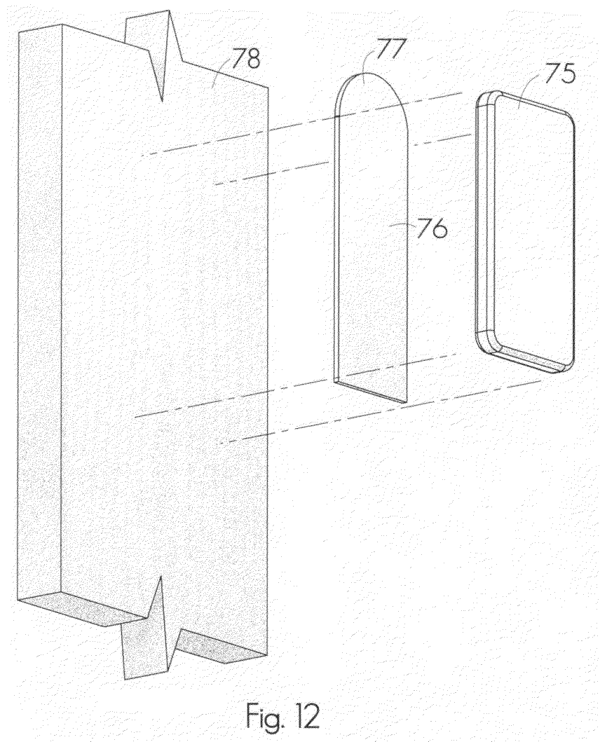

Once fully assembled, the display is brought near a ferromagnetic mounting surface (or magnetic adapters of FIG. 11 or 12) where it is attached to provide information, directions, or aesthetic value. In this example, the display remains at an approximate right angle to the mounting surface where it can be seen more readily from a distance in a hallway or similar use.

The safety cable 23 is attached to the mounting surface at loop 24 using a screw, hook, or other catch, set into the mounting surface just above the magnetic mounting point. A safety cable is supplied with all embodiments although it is only shown in FIG. 2.

The display support bracket can be accessorized to fit the occasion. Various decorations and accents may be added such as fabrics, buttons, beads, decorative paper, photos, cut-outs, etc.

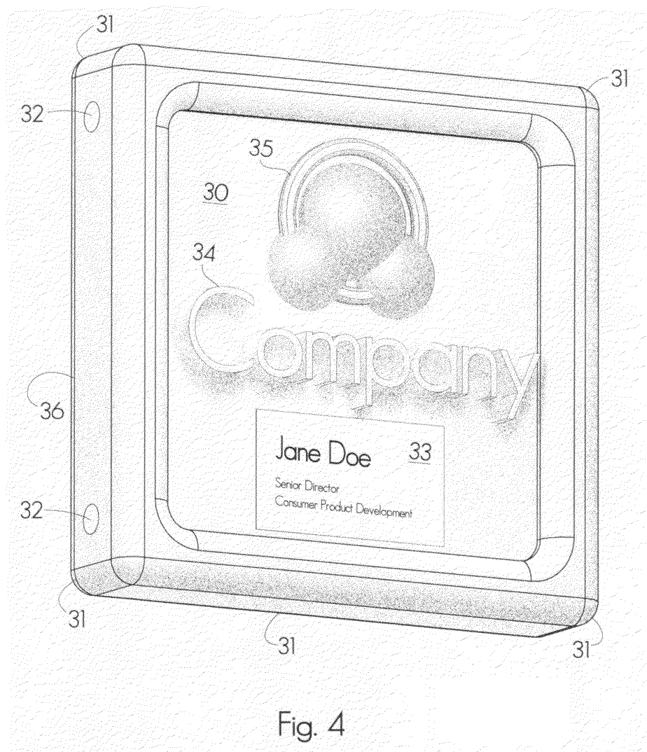

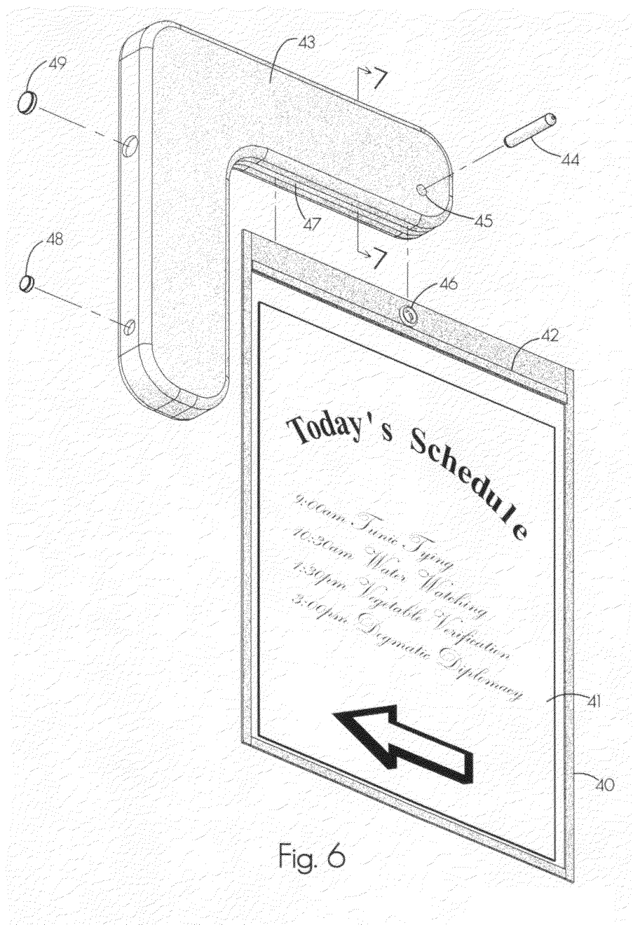

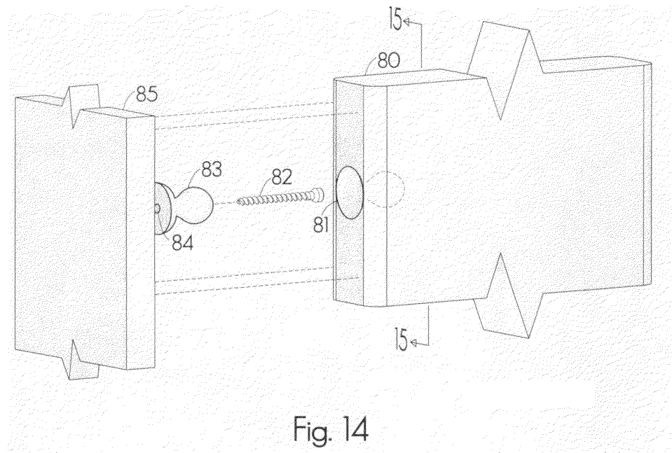

### FIGS. 4-18—Additional Embodiments

FIG. 4 illustrates a display without a hanging display holder. Instead a sheet, or card in this case 33, can be mounted directly onto the display bracket 30 using an adhesive or inserted in a clear plastic holder that is adhered to the display bracket. Low density foam can be expanded in a mold to create three-dimension shapes, like the raised lettering example 34 and raised company logo example 35. The front image shown is typically repeated on the rear 36, but could be different. All edges and corners 31 are rounded and beveled to minimize impact damage. This display is attached to a mounting surface via magnets 32. For some products, item 33 can be much larger, taking up the entire face of the display support bracket if items 34 and 35 are not present.

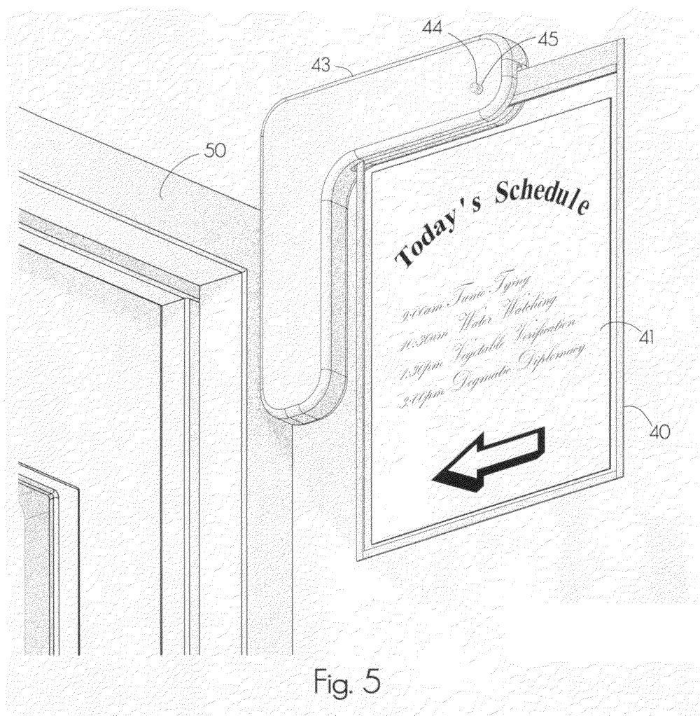

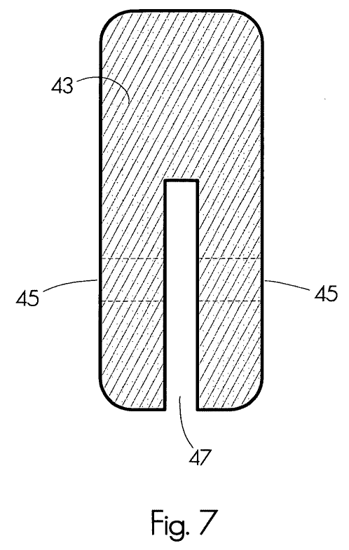

The embodiment display support bracket 43 of FIGS. 5-7 is attached to the mounting surface 50 with magnets 48 and 49 as in previous examples, but here the upper magnet 49 is shown larger than lower magnet 48 because the force on the upper magnet is larger. The user changeable display 41 is held with a sheet holder 40 similar to the Avery® Job Ticket Holder VJH4129-10/75009. Display sheets can be removed or inserted via slot 42. The sheet holder is attached to the display bracket 43 by inserting the sheet holder into the display receiving slot 47. Then the display sheet protector attachment pin 44 is inserted into the display bracket's attachment pin hole 45 and also into the grommet 46 of the display protector then continuing to the other side of hole 45. FIG. 7 is a cross section revealing how slot 47 can be used to contain the upper part of the sheet holder and shows the two sides of hole 45.

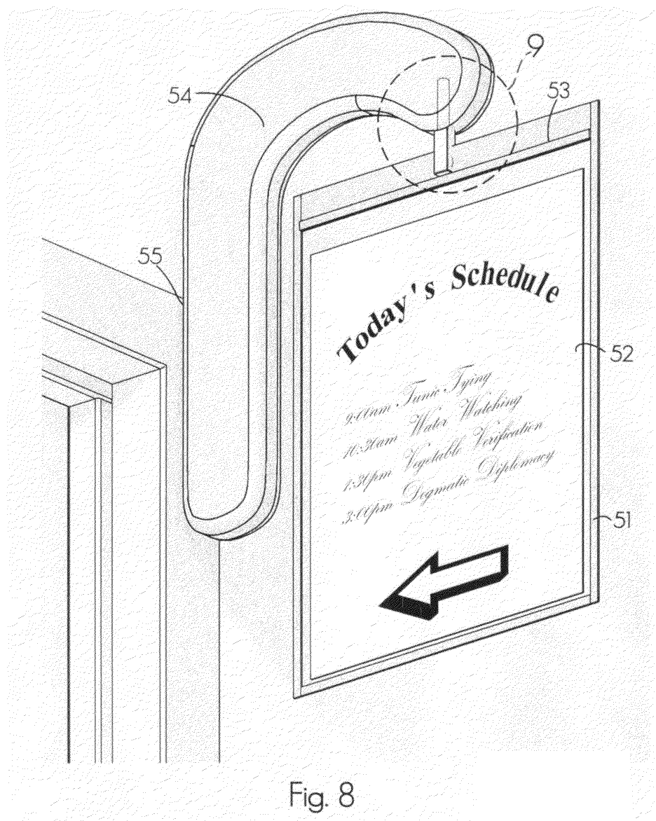

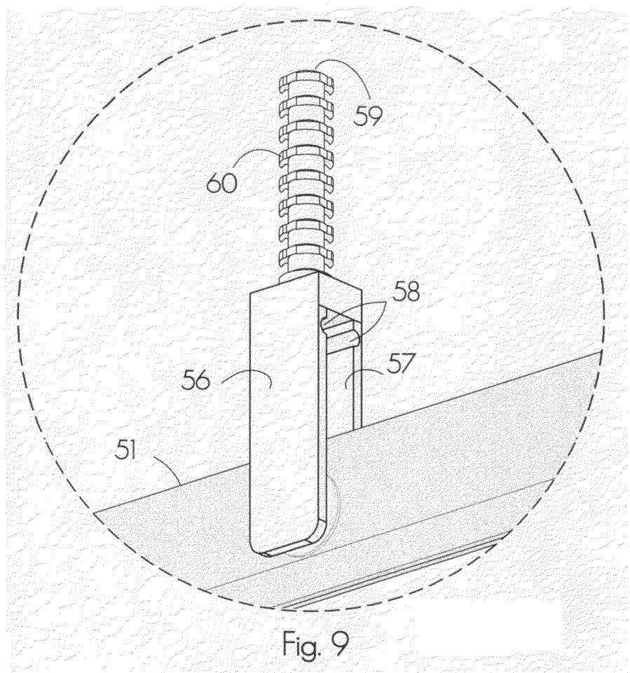

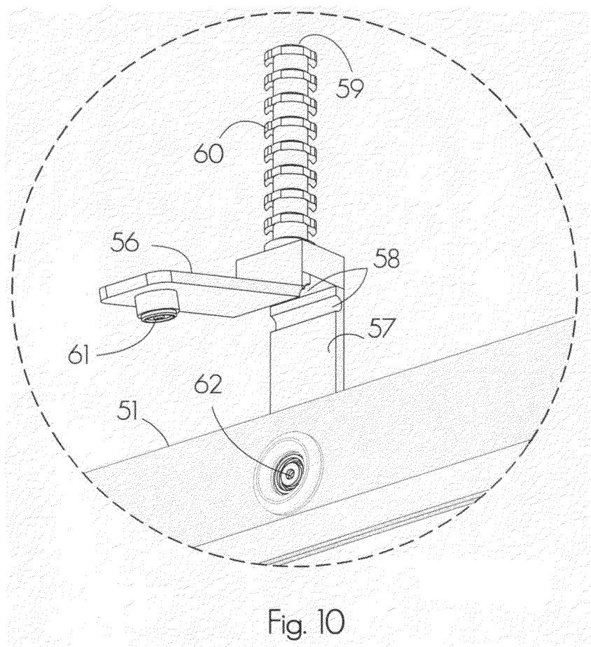

FIG. 8 is another example of a soft display support bracket 54 also magnetically attached 55 (not visible) to the mounting surface, but this embodiment suspends the display 52 and display sheet protector 51 by means of device detailed in FIGS. 9 and 10. With this design, displays 52 can be installed and removed via slot 53 without detaching the display sheet protector 51 from the display support bracket 54.

FIG. 9 shows one possible suspension device in more detail and FIG. 10 shows it in a partially open position, although many prior art means are available. During manufacture or initial user assembly, support post 59 is push into a hole drilled into the display support bracket. Flutes 60, that are angled down, prevent the suspension device from falling out while supporting the weight of the display 52 and sheet protector 51. Two snap attachment legs, 56 and 57, reach around the sheet protector 51 and snap together within the sheet protector grommet hole via male snap pin 61 and female snap hole 62. Small grooves 58 at the top of arms 56 and 57 allow said arms to swing out for attaching or detaching the sheet protector 51.

FIG. 11 is a simple optional adapter to allow magnetically supported display brackets to attach onto a non-ferromagnetic surface such as wood, plastic, or aluminum. A simple wood or metal screw 70 passes through the magnet attachment surface 71, typically a thick steel washer like device, via beveled hole 72 into the mounting surface 73. Once a couple of these devices are attached, the displays from FIGS. 1, 2, 4, 5, 6, and 8 can quickly attached to most any surface.

For customers who do not wish to damage the mounting surface with screws, FIG. 12 provides another optional adapter in which a magnet attachment surface, typically just a small piece of flat steel 75, is adhered to a non-magnetic mounting surface 78. The adhering material could be an ordinary adhesive or, as shown in FIG. 12, a 3M Commander® removable strip adhesive 76 with a removal tab 77 for minimal damage to the mounting surface.

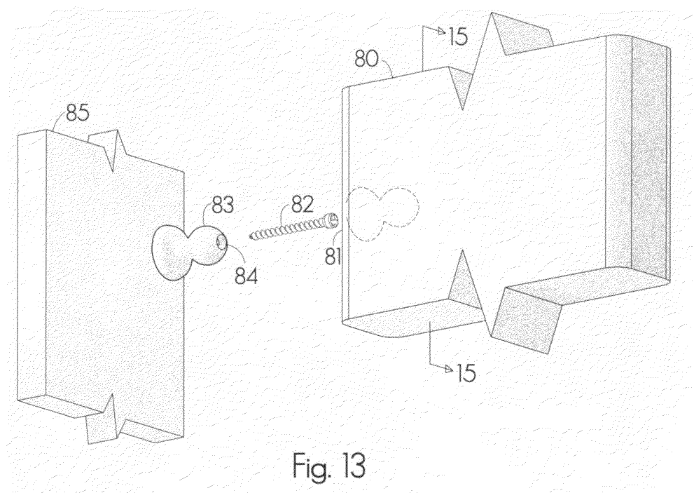

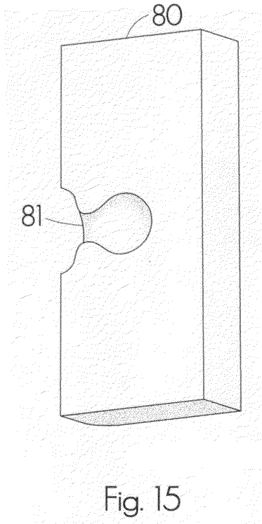

A non-magnetic attachment means is provided in FIGS. 13-15. The display support bracket 80 contains an attachment hole 81, which is a void in the shape of the attachment ball 83. The attachment ball 83 can be screwed into the mounting surface 85 with a screw 82 via a longitudinal hole 84. When the customer wants to attach the display support bracket 80, they simply align attachment hole 81 with attachment ball 83 and push. The material of display support bracket 80 is flexible enough to expand around the attachment ball 83, but stiff enough to hold the display upright under the force of gravity. Detaching the display support bracket 80 requires a modest pull of the display away from the mounting surface. FIG. 15 shows a cross section of the attachment hole void. Although one ball and hole may suffice for smaller displays, it is expected that most display units will make use of two or more of these attachment ball and hole combinations.

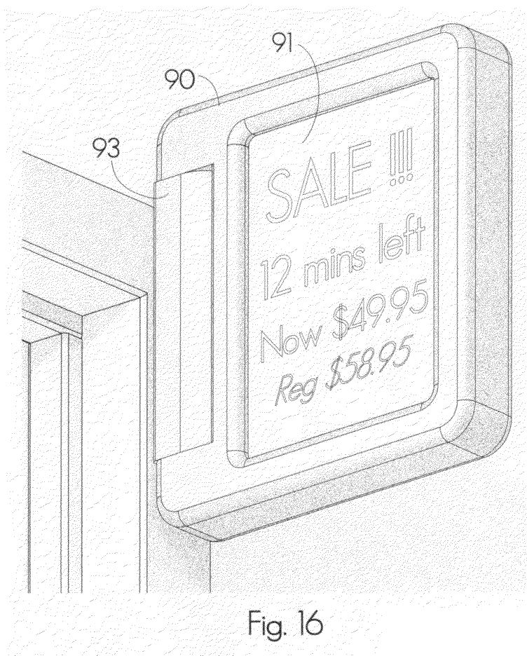

FIG. 16 is a liquid crystal display (LCD) unit 91 encased in soft polyethylene foam or other impact-resistant material forming the display support bracket 90 that protects the display, people, and other items from accidental impact due to collision or accidental detachment. The display, like previous examples can be one sided, two sided, or rarely three or more sides. In this example, the LCD 91 is secured within the display support bracket by a slot 101. The LCD is installed into slot 101 by slightly stretching the display support bracket over and around the LCD.

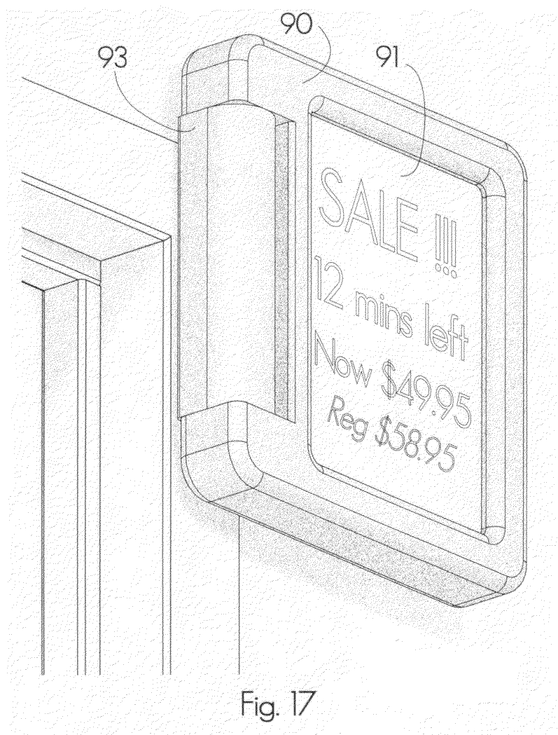

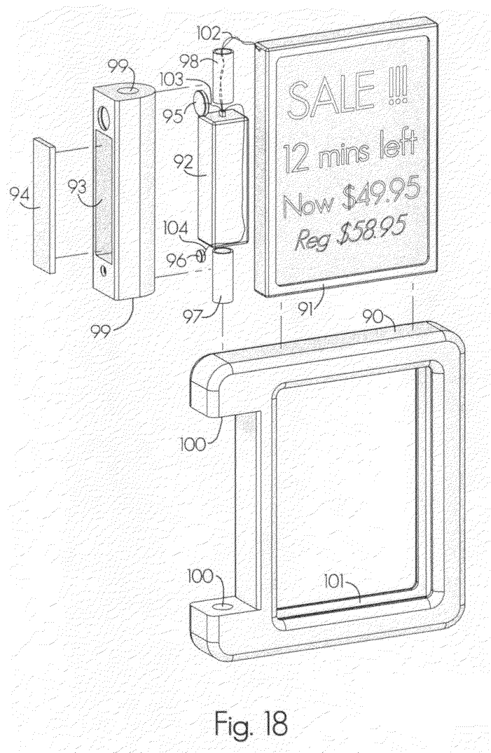

Items 90 and 93 are articulated to allow the display portion to be rotated to any position within about 180 degrees, but typically from perpendicular as shown in FIG. 16 to flat as shown in FIG. 17. This swivel option can be applied to any previously described embodiment, but is detailed here because of the added requirement for wires to power the LCD. FIG. 18 shows the internal details of a preferred embodiment.

Item 93 acts as a battery compartment, surface attachment support, and swivel base. The battery 92 is likely to be a high-capacity rechargeable type. To make recharging easier, the magnets 95 and 96 coated with nickel, gold or other oxidation resistant conductor, can act as both support devices and battery recharging conductors. That is, the display can be recharged when removed from the mounting surface and placed in a recharging unit. In addition, power can be provided by contacts embedded on the wall, door frame, or other attachment surface to continuously feed power to the display, in which case a battery would be unnecessary. The battery compartment door 94 is attached with traditional snap fit or screws, not shown. Holes 99 provided a place to insert bearing tubes 97 and 98 which then extend into holes 100 so that the display support bracket 90 can rotate with respect to 93.

Wires 103 and 104 provide a conduction path from the magnets 95 and 96 to the battery 92. Bearing tubes 97 and 98 are hollow to allow wires 102 to carry power from the battery compartment to the LCD 91, while also providing a means for articulation between 90 and 93.

The LCD unit 91 is an embodiment that allows customers to provide a dynamic display of information. While the display in some of the other embodiments can be changed easily, this unit shows that the information content can be dynamic. The information can be programmed to display the same information until it is reprogrammed or change rapidly, such as a new screen every few seconds. It can be programmed to display video and audio moving picture type information. It can be programmed to display different information depending on the time of day, day of the week, or for special events. Using a optional motion detection system, such as a infrared motion detection diode, the display can activate when someone approaches, thus saving power and making a greater impact.

The LCD unit 91 includes a backlight, microprocessor, storage memory, and a means of information transfer. The information to be displayed is transferred to the display by use of a radio receiver, infrared receiver, wired serial connection, flash memory card, or other prior art means. The microprocessor is programmed to control the LCD display of static, dynamic, computed, and up to date information.

### Conclusion, Ramifications, and Scope

The availability of durable, lightweight materials with low mechanical impact characteristics, combined with easily changed information content, also combined with magnetic or quick change attachment that can be configured perpendicularly, results in several improvements including:
Increased safety
Enhanced visibility, especially in hallways and aisles
Ability to rapidly change content
Ability to rapidly change content location
Less damage from fastener holes

With respect to the above description then, it is to be realized that the optimum relationships for the parts of the invention, to include variations in materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention. For example, the magnets shown are small button type, but most any type of sufficient strength could be used including: strips, cup enclosed, rods, tubes, and channels. Numerous non-magnetic attachment methods are prior art including: hook & latch like Velcro®, slip locks, hooks, latches, friction fittings, and adhesives. The display holder bulge is depicted as round, but could be of most any shape that doesn't allow the display holder to easily fall out including: elliptical, triangular, and rectangular. There are many other means to connect the display holder with the display bracket. The display bracket is shown as solid polymer foam, but any soft material would be suitable including: synthetic and natural rubber, and silicon. Additionally, the bracket could contain a solid core with soft coating(s). A specific type of display holder is shown, but any lightweight and soft display holder is useable.

One possible use of these portable, easily changed displays is to allow emergency personnel to denote exit paths, temporary health care or triage facilities, emergency supplies, search and rescue entry information, disaster shelter room assignments and rules.

In addition to simple static visual information being displayed, the device can be configured to display dynamic visual information using LED or LCD technology, audio information with a speaker, olfactory scents, mechanical movement such as a ball on a string moving up and down to attract attention, and could be used to dispense product samples. To save power and increase attention, dynamic events can be triggered by a motion detector such as typical an infrared diode and lens system.

I claim:

1. A device for communicating information, directions, decorations:
(a) comprised of or coated with a low mechanical impact material or materials,
(b) easily demountable fasteners,
(c) and changeable signage,
the improvement wherein
a support bracket made of said material or materials having said fasteners attached on one side and said changeable signage visible on one or more other sides attached to said support bracket on, under, or partially inside said support bracket wherein the assembled display device may be mounted perpendicular to a mounting surface.

2. The display device of claim 1 wherein said low mechanical impact material or materials include any material that is soft enough to reduce injury or property damage, sag resistant enough to support signage, lightweight enough to minimize injury or property damage, and lightweight enough to prevent accidental demounting.

3. The display device of claim 1 wherein said low mechanical impact material or materials include items selected from the group of polymers, polymer foam, thermoplastic elastomers, polyethylene foam, low density polyethylene foam, linear low density polyethylene foam, polypropylene foam, polyurethane foam, polystyrene foam, polysiloxane, polyoefin blends, copolymers, elastomeric alloys, thermoplastic polyurethanes, thermoplastic copolyester, thermoplastic polyamides, polyisocyanurate, flexible synthetic rubber, ethylene propylene diene monomer rubber, and flexible natural rubber.

4. The display device of claim 1 wherein said support bracket may be comprised of a rigid core of any solid material that is covered or coated with said low mechanical impact material or materials.

5. The display device of claim 1 wherein said fasteners include items selected from the group of magnets, magnet assemblies, neodymium magnets, and magnets in combination with ferromagnetic materials adhered to the said mounting surface.

6. The display device of claim 1 wherein said fasteners include a knob extending from the mounting surface that is fitted into a hole in the support bracket. The tendency of the support bracket material to retain it's shape holds the display onto the knob. Thus the support bracket and display assembly may be easily attached and detached intentionally but will not detach under the force of gravity of lightweight displays.

7. The display device of claim 1 wherein the assembled display device may be mounted perpendicular to a mounting surface and optionally be rotated to also mount flat in parallel with the mounting surface either by articulation or side mounted fasteners.

8. The display device of claim 1 wherein the support bracket may contain embossed or engraved letters, symbols, logos, and other decorations or information.

9. The display device of claim 1 wherein the display signage consists of paper, photographs, thin printed or cut polymer material such as a vinyl sign, liquid crystal display, light emitting diode display, lamp to illuminate a paper or polymer display, or screen with projected image including dynamic or static information display and optionally audio information.

10. The display device of claim 9 wherein the liquid crystal display, light emitting diode display, lamp, projector, or other devices requiring electrical energy receives electrical energy by electrical conduction through support bracket magnets that are coated with nickel, gold, or other low oxidation metal or conductive material.

11. The display device of claim 10 wherein the electrical energy is supplied by a charger through the support magnets to a battery. Once removed from the charger, the battery provides electrical energy.

12. The display device of claim 10 wherein the electrical energy is supplied by contacts on the mounting surface that also provide a means to mechanically support the display. Said contacts can be made of nickel or gold plated steel or other ferromagnetic conducting materials.

13. The display device of claim 1 wherein the display signage is attached to the support bracket by a bulge in the display signage that slides into a slot in the support bracket, an adhesive, a pin mechanism, a snap lock mechanism, or numerous other prior art mechanisms.

14. A portable sign or display comprised of
(a) a prior art device or devices for the communication of information including light reflecting paper signs, photographic display, flat or 3D letters or symbols, and light emitting devices such as liquid crystal displays (LCD), light emitting diodes (LEDs), incandescent or arc vapor backlighting or projection,
(b) a “soft” encasement of foam as a means to protect people from direct impact with the display, to protect people from the display being accidentally detached and impacting people, to protect the display and display supports from damage either directly or indirectly, and to protect property around the display if the display becomes detached and impacts said property.
(c) magnets, attachment balls, or other quick release mechanical attachment systems as a means to support and connect the sign or display to a mounting surface in such a way that the sign or display can be mounted perpendicularly to a vertical surface or ceiling and easily removed, signage quickly changed, and then quickly put back into service, perhaps at a different location.

15. A display device, sign, or decoration comprised of:
a) a magnet, magnets, non-magnetic surface adapters, bulge-hole-fit attachment device, and/or other prior art quick connection devices.
b) a display support bracket, pole, extrusion, plate, or foam molding containing or connecting with said magnets or other attachment devices in a) above that also supports, contains, or is formed into an information display c) below.
c) a paper, photographic, printed, hand drawn, plastic, mold formed, LED, LCD, static or dynamic visual and/or audio display, sign, or decoration
wherein such display can be attached or rotated out of the plane of the support surface such as a door frame or hallway wall and in particular can appear at an approximate right angle to the support surface.
